(19) United States
(12) Patent Application Publication
(10) Pub. No.: US 2013/0229807 A1
(43) Pub. Date: Sep. 5, 2013

(54) STREET LIGHTING FIXTURE

(71) Applicant: Tinson HUANG, Guangdong Province (CN)

(72) Inventor: Tinson HUANG, Guangdong Province (CN)

(73) Assignee: TEEMWAY INDUSTRIAL LTD, Guangdong Province (CN)

(21) Appl. No.: 13/426,083

(22) Filed: Mar. 21, 2012

(30) Foreign Application Priority Data
Mar. 1, 2012 (MX) MX/A/2012/002622

(51) Int. Cl. F21V 7/04

(52) U.S. Cl. 362/296.07

(57) ABSTRACT

A street lighting fixture having a flat upper surface designed to increase the inner space of a reflector, allowing to install induction lamps of great size solving the problem of universality, additionally having a trapezoidal-shaped convex central portion which facilitates the installation of the lamp.

### BACKGROUND OF THE INVENTION

A. Field of the Invention

B. Disclosure of the Related Art

Nowadays, technological development related to public lighting is focused to increase the useful life of the fixtures maintaining a high light intensity with low energy consumption. Induction lamps are high technology lighting accessories following said development focus.

Induction lighting is incorporated in a new lamp type based on the theory of the high frequency plasma discharge. Said new fixtures are a new scientific and technological achievement related with the optical, power electronics, plasma science and materials science, and have the advantage of being highly efficient, have a long useful life, a high color rendering index, being environment friendly and achieve great energy savings. They are suitable to be installed in tunnels, high traffic zones, subway stations, vestibules and other public areas.

The current induction lamps are designed to be uses in private fixture structures having complicated structure, having a high cost and a low universality. As the upper part of the traditional fixture is a completely flat surface or comprising a single curve surface, the inner space is limited and is not suitable for installing a large induction lamp. The light source of a traditional fixture is installed directly at the top, causing a low convergent effect. Besides, the space at the ballast holder is fixed, so that it can be installed a single ballast of the same size.

In view of the disadvantages formerly mentioned of the existing technology, applicant developed a fixture which has an induction lamp having an improved form and structure regarding the currently existing fixtures.

The fixture of the present invention comprising: a housing, a reflector, a support which is connected to the housing by means of a screw, a removable cover art which can be penetrated by the light at the lower part of the housing, an aluminum cover and a lid.

Wherein said reflector including an upper flat surface, convex curved side surfaces and a transition surface between them, all of them coated with a vacuum electroplated reflective layer; its central portion having a convex trapezoidal form which allows the installation of the light source, and the transition surface is curved and wherein said reflector is made of aluminum.

Furthermore, a housing for installing the fixed ballast holder is included in said support, which is removable and can be connected my means of two fixed ballast holders, each of which has a bore for the ballast installation, Preferably, the convex trapezoidal form of the upper part of the reflector is designed to be integrated with the upper part.

The fixture of the present invention has the following advantages regarding the current fixtures: in the first place, instead of having a single flat or curved surface existing in the traditional fixtures, it has a flat upper surface designed to increase the inner space of the reflector, which allow to install large induction lamps, solving the problem of the universality. In the second place, the reflector has a central portion of convex trapezoidal form, which facilitates the installation of the lamp. Besides, the distance between the lamp and the reflector is greater regarding the current fixtures, increasing in this way the efficiency of the fixture. As the inner surface of the reflector has a vacuum electroplated metallic coating, the reflector achieves an excellent reflecting effect. Last but not least, the support is fixed with rivets at one side and with screws at the other side and there is a housing for installing the fixed beams. Said design has the advantage that ballast of diverse size can be installed.

### SUMMARY OF THE INVENTION

It is therefore a main object of the present invention, to provide a fixture comprising: a housing, a reflector a support which is connected to the housing by means of a screw, a removable cover art which can be penetrated by the light at the lower part of the housing, an aluminum cover and a lid.

It is another main object of the present invention, to provide a fixture of the nature above disclosed which, instead of having a single flat or curved surface that existing in the traditional fixtures, it has an upper flat surface designed to increase the inner surface of the reflector, which allows to install induction laps of great size, solving the problem of the universality.

It is still a main object of the present invention, to provide a fixture of the above disclosed nature, in which the reflector has a central portion having a convex trapezoidal form which facilitates the installation of the lamp.

It is an additional object of the present invention, to provide a street lighting fixture of the above disclosed nature, wherein the distance between the lamp and the reflector is bigger regarding the traditional fixtures, so that increases the efficiency of the fixture.

It is another additional object of the present invention, to provide a fixture of the above disclosed nature, wherein the inner surface of the reflector is coated with a vacuum electroplated metallic layer, achieving in this way an excellent reflecting effect

It is still an additional object of the present invention, to provide a fixture of the above disclosed nature, in which ballast of diverse size can be installed.

These and other objects and advantages of the present invention will became apparent to those skilled in the art, from the following detailed description of the invention.

### BRIEF DESCRIPTION OF THE DRAWINGS

FIG. 1, is a perspective exploded view of the Street lighting fixture of the present invention;

FIG. 2, is a lower view of the housing of the street lighting fixture of the present invention;

FIG. 3, is an upper view of the housing of the street lighting fixture of the present invention;

FIG. 4, is a frontal perspective view of the support of the street lighting fixture of the present invention;

FIG. 5, is a rear perspective view of the support of the street lighting fixture of the present invention;

FIG. 6, is an upper view of the aluminum cover art for the ballast of the street lighting fixture of the present invention

FIG. 7, is an upper view of the concave reflector of the street lighting fixture of the present invention FIG. 8, is a perspective view of the concave reflector of the street lighting fixture of the present invention; and

FIG. 9, is a lower view of the circular holding frame of the street lighting fixture of the present invention.

### DETAILED DESCRIPTION OF THE INVENTION

The fixture of the present invention will now described referring to a preferred embodiment thereof and in combination with the accompanied drawings, wherein the same signs refer to the same drawn elements.

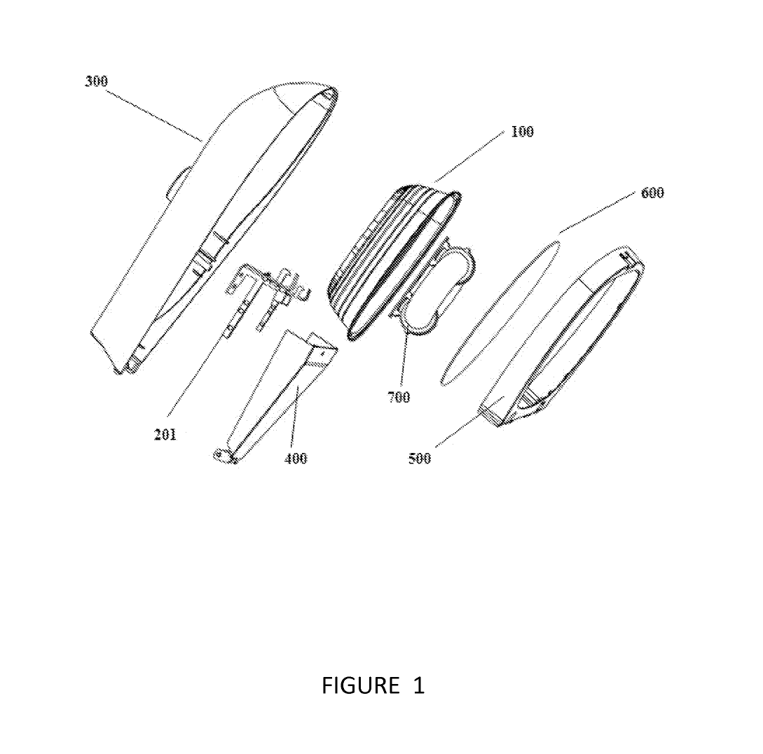

Referring to FIG. 1, the fixture of the present invention comprising in its most general embodiment:

a housing 300, comprising a concave shaped member, like a drop, having a first end and a second end and an inner surface;

a support 200, comprising a flat enlarged member, connected to the inner surface of the housing 300 at a portion near to the longitudinal center thereof;

a ballast aluminum cover 400, having a first end joined to the support member 201 and a second joined to the second end of the housing 300;

a concave reflector 100, lodged in the concave inner surface 304 of the housing 300;

an induction lamp 700 joined to the concave reflector 100; and

a circular holding frame 500, having a first end and a second end wherein the second end is joined to the support 201 and the first end is joined to the first end of the housing 300 and in turn is joined to the concave reflector 100, wherein the circular holding frame 500 supports the concave reflector 100 besides to the induction lamp and a translucent cover art 600 within the housing 300.

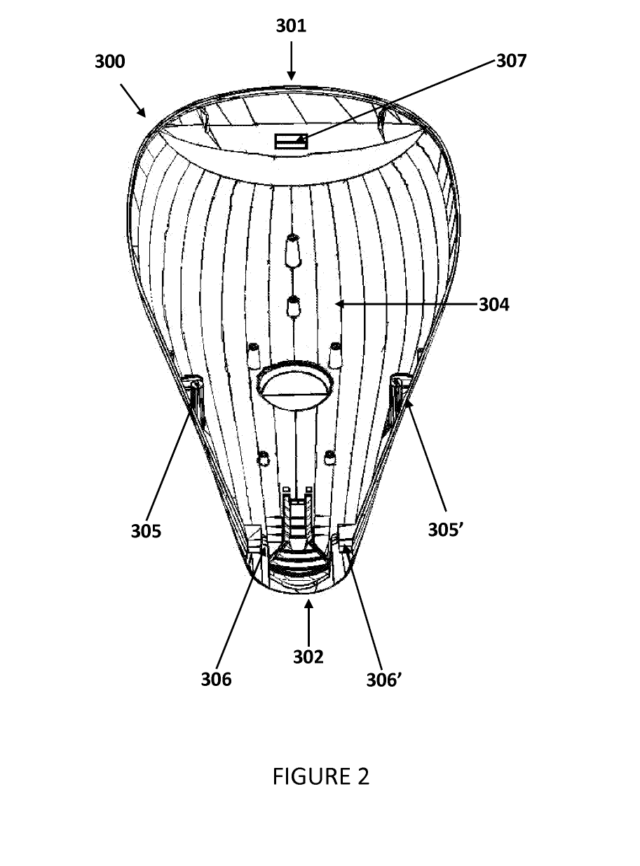

Now, referring to FIGS. 2 to 9, the fixture of the present invention comprising, in a specific embodiment:

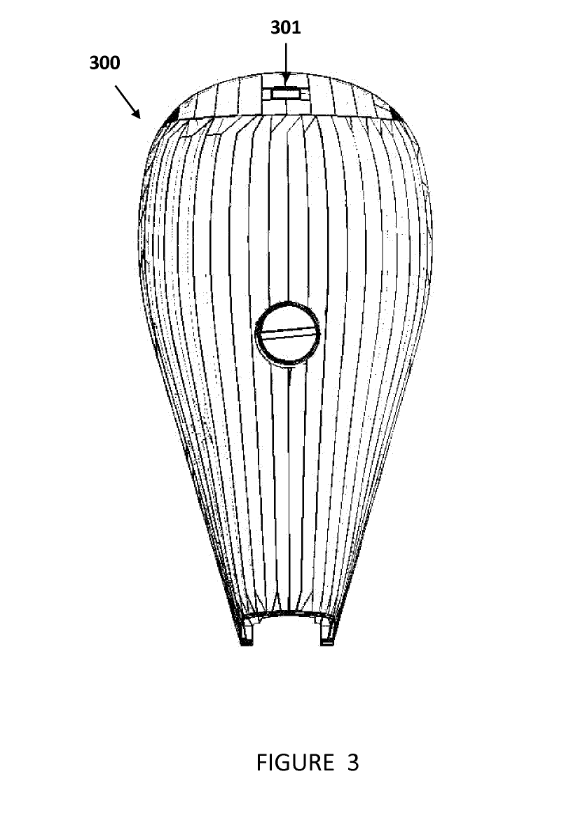

a housing 300 (FIGS. 2 and 3) comprising a concave shaped member, like a drop, having:
a first end 301 and a second end 302;
an outer surface 303 and a concave inner surface 304;
a first bearing 305 and a second bearing 305′, each having a bore and each depending from the inner wall 304 of the housing 300, at opposite sides near to the second end 2 thereof;
a first pivotal housing 306 and a second pivotal housing 306″, each one depending from the inner wall periphery 304 of the housing 300 at opposite sides of the second end 302 thereof;
a bore 307, located at a central portion of the first end 301 of the housing 300;

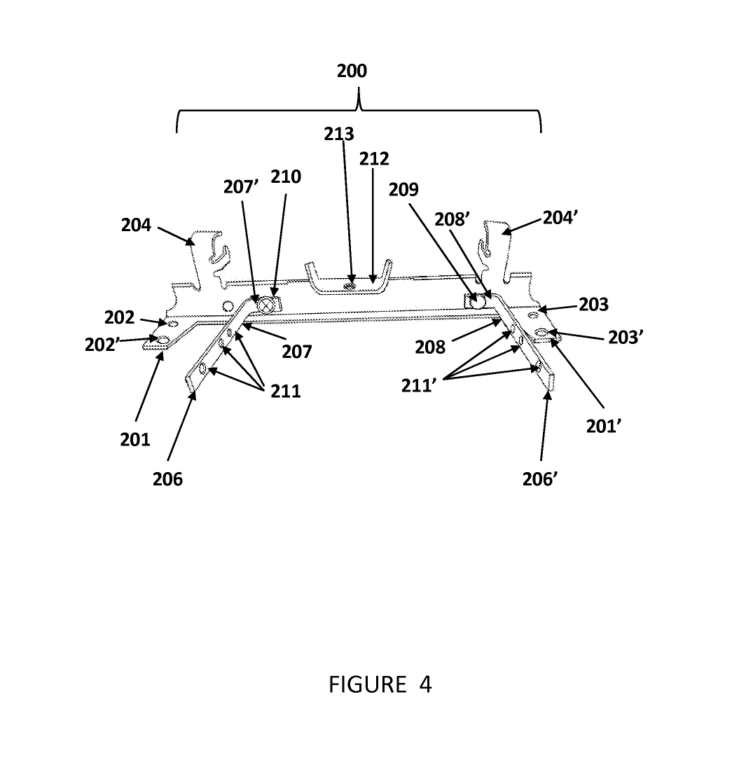

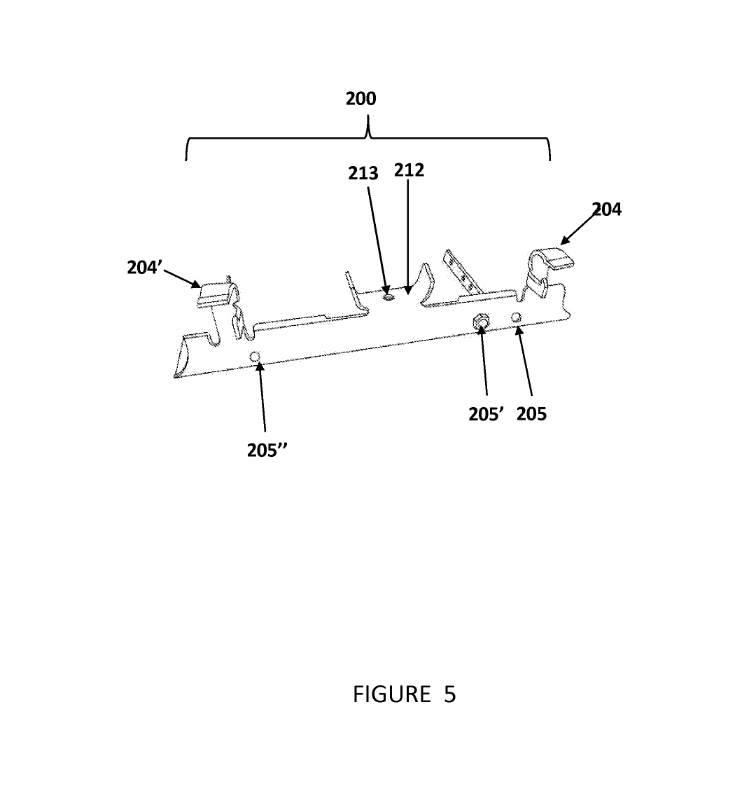

a support 200 (FIGS. 4 and 5) comprising an elongated flat member connected to the housing 300 by means of screws, having:
a first connecting member 201 and a second connecting member 201′ for connecting the housing 300, each of which comprising a flat member depending directly from opposite ends of a lower portion of the support 200, in a perpendicular way thereof, wherein said first connecting member 201 and second connecting member 201′ each includes a pair of bores 202, 202′, 203, 203′ wherein the bores 202′ and 203′ each receive a screw which is screwed to the bores of the first bearing 305 and second bearing 305′ respectively, joining in this way the support 200 to the housing 300;
a first joining hook 204 and a second joining hook 204′, each depending from an upper portion of the support 200 and each located near of a respective end thereof;
three bores 205, 205′ and 205″, two thereof 205′, 205″ located near of an end of the support, next one to the other and the remaining bore 205 located near the opposite end of the support;
a first ballast holder beam 206 and a second ballast holder beam 206′, each having a square shape with a main section 207, 208 and a support joint section 207′, 208′, which has a bore, wherein:
   the joint section 208′ of the second ballast holder beam 206′ is fixedly joined to the support 201 by means of a rivet 209 passing through the bore located in said joint section and through the bore 205″;
   the joint section 207 of the first ballast holder beam 206 is removable joined to the support 201 by means of a screw 210 passing through the bore located in said joint section and through the bore 205′ so that said first beam 206 can be unscrewed from said bore 205′ and screwed to the next bore 205, so that the distance between both ballast holder beams 206, 206′ can be varied in order to hold ballast of different size;
   the main section 207, 208 of the first beam 206 and the second beam 206′ having a plurality of bores 211, 211′ to facilitate the installation of a ballast;
   a member 212 to screw an aluminum cover 400, comprising a “U”-shaped member depending directly from an upper central portion of the support 200, wherein said support 212 includes a bore 213;

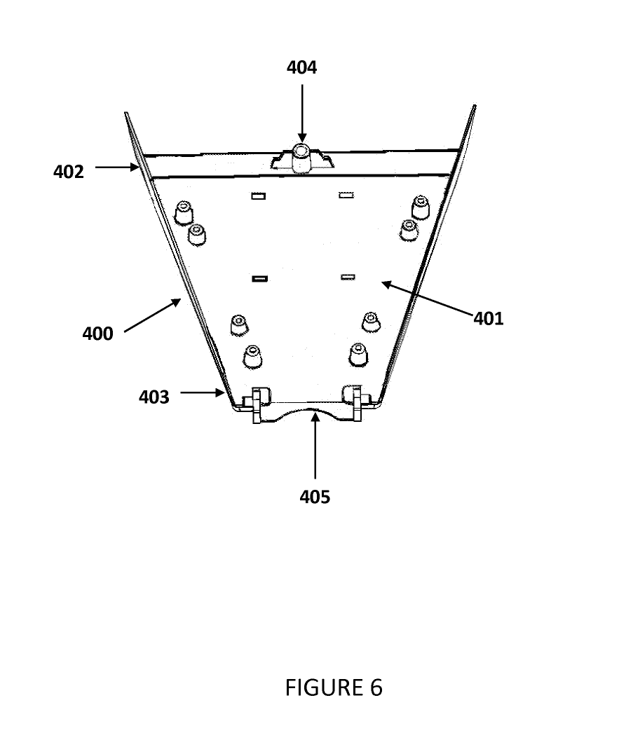

an aluminum cover 400 for a ballast (FIG. 6) having a “U”-shaped cross section, formed by two side walls depending from a lower wall and having:
an inner wall 401 and an outer wall (not shown);
a first end 402 and a second end 403;
a bearing having a bore 404 depending from the inner surface 401 at the central portion of the first end 402, to receive a screw to be screwed to the bore 213 of the support member 200, wherein the first end 402 is attached to the support 200;
a hinge 405 depending from the inner surface 401 of the second end 403, which is pivotally placed in the first housing 306 and second housing 306′, for pivoting of the housing 300, pivotally joining in this way the second end 402 of the aluminum cover 400 to the second end 302 of the housing 300

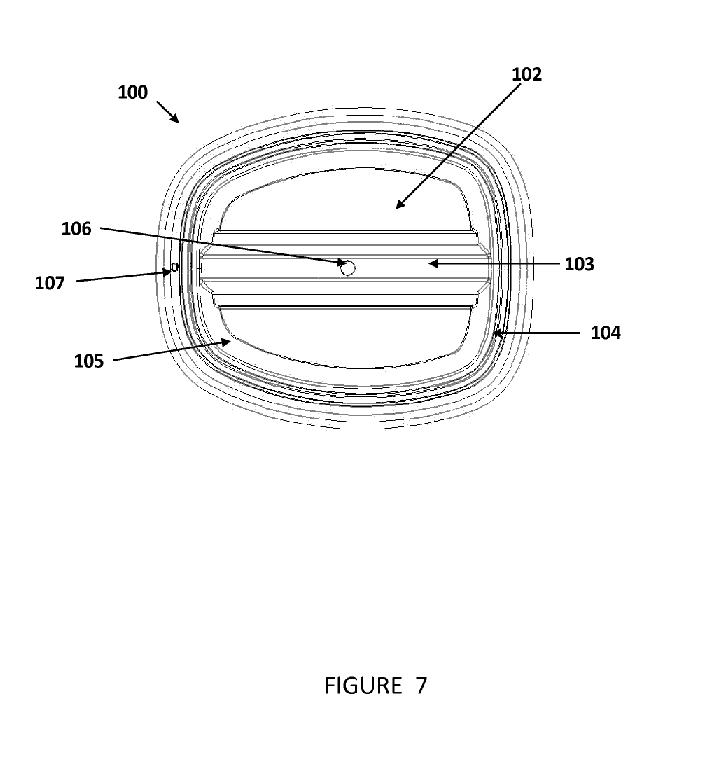

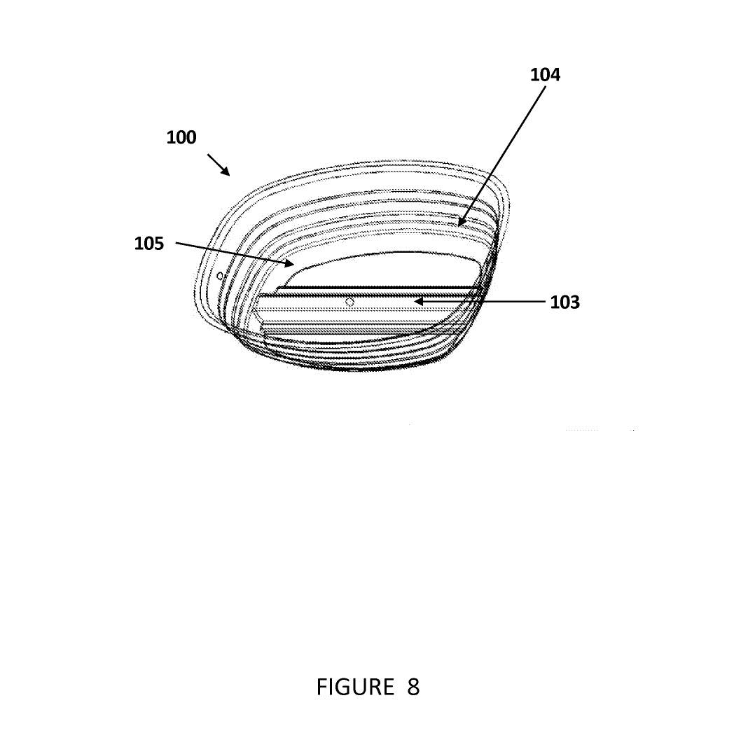

a concave reflector 100 (FIGS. 7 and 8) placed at the concave inner surface 304 of the housing 300, having a concave inner surface 102 whole covered with a layer of a vacuum electroplated reflecting metallic material and an outer surface, wherein:
the upper part of the concave inner surface 102 is flat; the central part having an enlarged trapezoidal projection 103 crossing all the reflector from edge to edge and which depends form the upper wall of the concave inner surface projecting thereto; and the inner surrounding edge 104 has a curve convex shape to increase the reflecting surface, so that the reflected light could be diffused, allowing that the light be uniformly projected;
the transition surface 105 between the upper part and the inner surrounding edge is curve, which helps to increase the space within the reflector 100 at the maximum;
a bore 106 is included for the installation of a lamp;
a screwed bore 107 is included, placed at the inner surrounding edge to allow access to the feeding wires of the lamp; and
a translucent cover art 600 (FIG. 1) is included, joined to the edge of the reflector, completely covering the inner surface thereof;
an induction lamp 700 (FIG. 1) joined to the concave reflector 100 by means of screws (not shown) screwed to the bore 106;

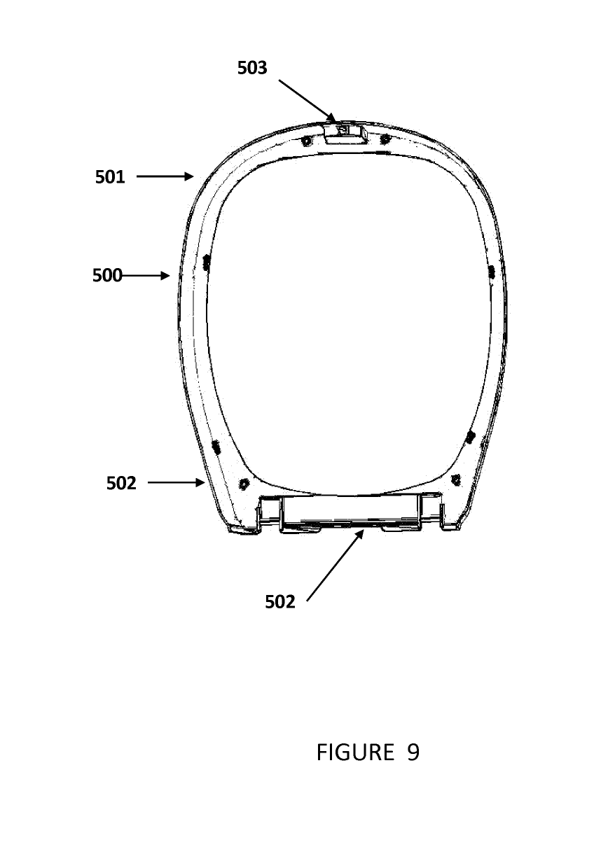

an circular holding frame 500 (FIG. 9) comprising a ring having the same oval peripheral shape that the housing 300, said circular holding frame having a first longitudinal end 501 and a second longitudinal end 502 including:

a bore 503 at one central portion of the first longitudinal end 501, to receive a screw which is screwed into the bore 301 of the housing 300, joining in this way the first end 501 of the circular holding frame 500, with the first end 301 of the housing;

a joining hinge 504, located at the second longitudinal end 502 of the circular holding frame, said joining hinge 504 pivotally joining the first joining hook 204 and the second joining hook 204′ of the support 200, and pivotally joining in this way the second end 501 of the circular holding frame 500 to the support 200 and therefore to the housing 300;

wherein the circular holding frame 500, holds the concave reflector 100 together with the induction lamp 700 and the translucent cover art 600 within the housing 300;

Finally, it should be understood that the street lighting fixture of the present invention, is not limited exclusively to the embodiments above disclosed and illustrated and that the persons ordinary skilled in the art could, with the teachings herein disclosed of the invention, make modifications to the street lighting fixture of the present invention, which will be clearly within the inventive concept and scope of the invention which is claimed in the following claims.

1. A street lighting fixture comprising:
a housing comprising a concave-shaped member having a first end and a second end and an inner surface;
a support comprising an elongated flat member, connected to the inner surface of the housing at a portion near to the longitudinal center thereof;
an aluminum cover for a ballast, having a first end joined to the support member, and a second end joined to the second end of the housing;
a concave reflector placed at the concave inner surface of the housing;
an induction lamp joined to the concave reflector; and
an circular holding frame having a first end and a second end, wherein the second end is joined to the support and the first end is joined to the first end of the housing and, in turn, is joined to the concave reflector, wherein the circular holding frame holds the concave reflector together with the induction lamp and the translucent cover art within the housing.

2. A Street lighting fixture in accordance with claim 1, wherein the housing additionally comprising:
a first end and a second end;
a first inner surface and a second concave inner surface;
a first bearing and a second bearing, each having a bore and each depending from the inner wall of the housing at opposite sides near to the second end thereof;
a first housing and a second housing for pivoting, each depending from the periphery of the inner wall of the housing at opposite sides of the second end thereof; and
a bore located at a central portion of the first end of the housing.

3. A street lighting fixture in accordance with claim 2, wherein the support additionally comprising:
a first housing connecting member and a second housing connecting member, each comprising a flat member depending directly from opposite ends of a lower portion of the support, perpendicularly thereto, wherein the first connecting element has a first bore and a second bore, and the second connecting member has a third bore and a fourth bore, wherein the first bore of the first connecting element receives a screw which is screwed to the first bearing of the housing and the third bore of the second connecting element receives a screw which is screwed to the bore of the second bearing of the housing, joining in this way the support with the housing;
a first joining hook and a second joining hook, each depending from an upper portion of the support and each located near the respective end thereof;
a first and a second bores located near to an end of the support, near one to the other and a third bore located near the opposite end of the support;
a first ballast holder beam and a second ballast holder beam, each having a square shape with a main section and a support joining section, having a bore wherein:
the joining section of the second ballast holder beam is fixedly joined to the support by means of a rivet passing through the bore located in said joining section and through the third bore of the support;
the joining section of the first ballast holder beam is removable joined to the support by means of a screw passing through the bore located in said joining section and through the first bore of the support, in such a way that the first beam can be unscrewed from said bore and screwed to the second bore, so that in this way the distance between both ballast holder beams can be varied;
the main section of the first beam and the second beam having a plurality of bores to facilitate the installation of a ballast; and
a member to screw the aluminum cover, comprising a “U”-shaped member directly depending from an upper central portion of the support, wherein said support includes a bore.

4. A street lighting fixture in accordance with claim 3, wherein the ballast aluminum cover additionally comprising:
an inner surface and an outer surface;
a first end and a second end;
a bearing having a bore depending from the inner surface of a central portion of the first end, for receiving a screw to be screwed into the bore of the member in order to screw the aluminum cover, wherein the first end of the aluminum cover is held to the support; and
a hinge depending from the inner surface of the second end, which is pivotally housed at the first housing and second housing so as pivoting the housing, pivotally joining in this way the second end of the aluminum cover to the second end of the housing.

5. A street lighting fixture in accordance with claim 1, wherein the concave reflector has a concave inner surface whole coated with a vacuum electroplated reflecting metallic layer and an outer surface, wherein
the upper part of the concave inner surface is flat; the central part has a trapezoidal-shaped elongated projection crossing all the reflector from edge to edge and that depends from the upper wall of the concave inner surface and projects thereto; and the inner surrounding edge has a curve convex shape to increase the reflecting surface, in such a way that the reflected light can be diffused, allowing that the light be uniformly projected;
the transition surface between the upper part and the inner surrounding edge is curve, helping to increase the space within the reflector at maximum;
it is included a bore for screwing an induction lamp;
it is included a screwed bore located at the inner surrounding edge to allow the access of the feeding wires for the lamp; and
it is included a translucent cover art joined to the edge of the reflector, completely covering the inner surface thereof.

6. A street lighting fixture in accordance with claim 3, wherein the circular holding frame comprising a ring having the same peripheral oval shape than the housing, said assuring circular frame having a first longitudinal end and a second longitudinal end and including:
a bore at the central portion of the first longitudinal end, to receive a screw which is screwed into the bore of the housing, joining in this way the first the first end of the circular holding frame with the first end of the housing;
a joining hinge located at the second longitudinal end of the circular holding frame, said joining hinge is pivotally joined to the first joining hook and second joining hook of the support, pivotally joining in this way the second end of the circular holding frame to the support and therefore to the housing.
